(19) United States
(12) Patent Application Publication
(10) Pub. No.: US 2014/0214549 A1
(43) Pub. Date: Jul. 31, 2014

(54) Method and Apparatus Selling Internet Products and Services Via Retail Locations

(71) Applicant: Saul Elbaum, Potomac, MD (US)

(72) Inventor: Saul Elbaum, Potomac, MD (US)

(21) Appl. No.: 13/754,960

(22) Filed: Jan. 31, 2013

(51) Int. Cl. G06Q 30/02

(52) U.S. Cl. CPC G06Q 30/0269
USPC 705/14.66

(57) ABSTRACT

A method of enabling the sale of products or services which are available on the internet which comprises selecting a retail location, providing the retail location with information about products or services available on the internet which includes a website address at which the products or services may be purchased and a code for use in making purchases which is correlated with the identity of the retail location, storing the code in a computer which is not located at the retail location, programming the computer to monitor incoming signals received from purchasers and after a code which is the same as the stored code is received, provide an indication of the identity of the retail location which is correlated with the code, and paying a finder's fee to the retail location.

### FIELD OF THE INVENTION

This invention relates to a method and apparatus of enabling the sale of products or services on the internet using retail locations.

### BACKGROUND OF THE INVENTION

The traditional method of selling products is through a retail store that carries an inventory of products. Typically, a prospective customer will enter the retail store, find the product being sought and purchase it. The customer may also find other products of interest in the same store. A problem with the traditional method of selling products is that stores can only carry a limited amount of inventory. Some stores provide customers with computers which enable them to locate and purchase products which the store does not carry in inventory. In both cases, however, the store purchases products from a manufacturer, wholesaler or retailer and then resells the products to the customer. The store may receive the product from the product source and then deliver it to the customer, or the store may arrange for the product source to ship the product directly to the customer. In either case, the payment is made by the customer directly to the store.

The internet method of selling differs from the traditional method in that it enables customers to find the lowest prices for products being sought. However unlike a store in which the customer may walk through and find other products of interest, the internet does not generally display products other than those being searched. The internet simply finds what the customer is seeking. Thus, an internet search is a good way to find competing sources of certain products, and a retail store is a good way to find new product ideas.

This invention enables both to be accomplished. It makes available information about products or services in a retail location, it creates a good way to find new product ideas, and it does not require the retail location to carry inventory of the products. At the retail location, the customer receives product information and a code identifying the retail location. If the customer is interested, the purchase is made from the seller on the internet, and after the sale is completed, the seller pays a finder's fee to the retail location. The customer, if he desires, after becoming aware of the products may also search the internet for competing sources.

### SUMMARY OF THE INVENTION

In accordance with the invention, a method of enabling the sale of products or services which are available on the internet is provided, which comprises selecting a retail location, providing the retail location with information about products or services available on the internet which includes a website address at which the products or services may be purchased and a code for use in making purchases which is correlated with the identity of the retail location, storing the code in a computer which is not located at the retail location, programming the computer to monitor incoming signals received from purchasers and after a code which is the same as the stored code is received, to provide an indication of the identity of the retail location which is correlated with the code, and paying a finder's fee to the retail location.

The invention will be more fully understood by reference to the accompanying drawings, which are described as follows:

### BRIEF DESCRIPTION OF THE DRAWINGS

FIG. 1 is a block diagram illustrating the prior art method of retailing.

FIG. 2 is a block diagram illustrating an embodiment of the invention.

FIG. 3 is a block diagram of an embodiment of a computer which is used to perform the invention.

### DETAILED DESCRIPTION

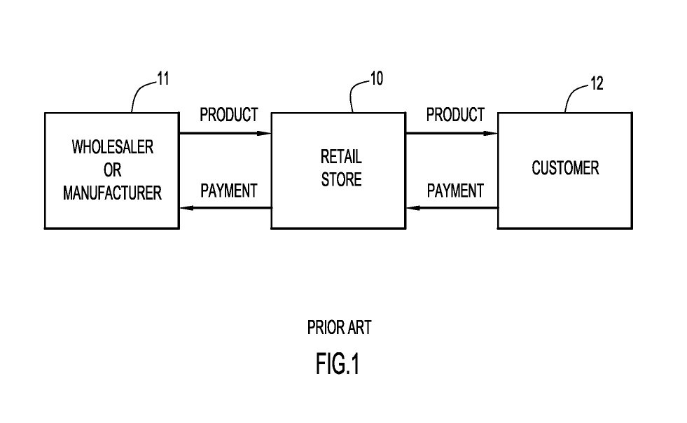

FIG. 1 illustrates the traditional prior art process in which a retail store 10 acquires product from a wholesaler or manufacturer 11 and then sells these products to its customer 12. The payments went first from the retail store to the wholesaler/manufacturer to purchase an inventory of the products, and then from the customer to the retail store to buy the products. This two-step process requires the retailer to invest in inventory and then wait for customers to come along and make individual purchases. Retailers are reluctant to hold large quantities of unsold inventories or products that occupy a large amount of space.

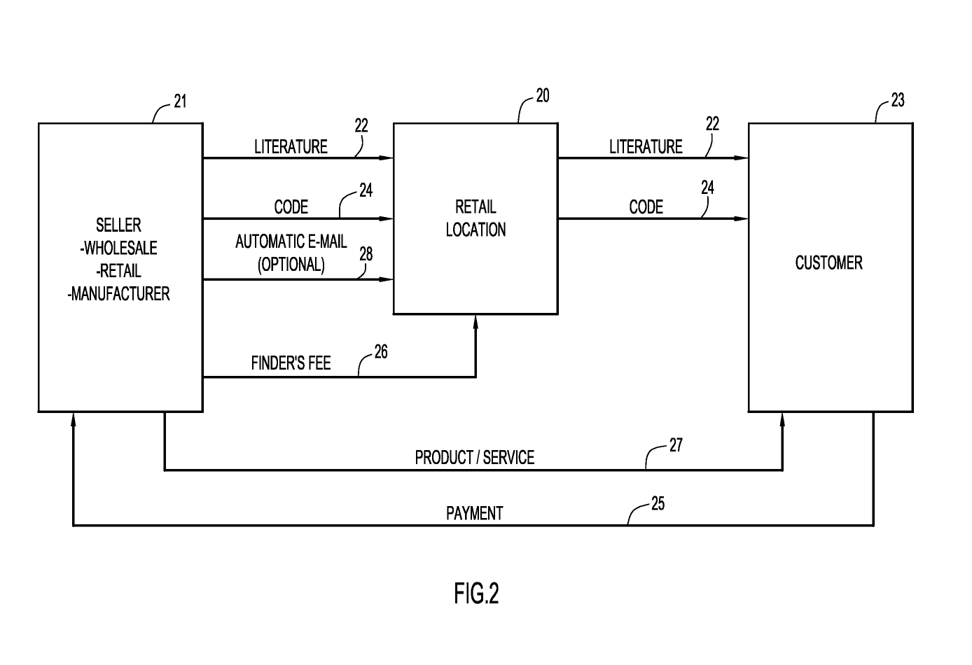

FIG. 2 illustrates an embodiment of the invention, in which the retail location 20 is not required to carry inventory. Instead, the retail location 20 carries display literature 22 such as pamphlets or brochures describing the product or products which are available from one or more sellers. In addition to products, the retail location 20 can also carry information about various services such as insurance, investment opportunities, beauty salons, etc. The literature 22 can be prominently displayed throughout the retail location 20 so that it's available to customers 23, and if desired, can be organized in various ways such as by subject matter, by end use, alphabetically, etc. The literature can be made available either free of charge or for a fee. The initial cost of providing the literature can be at the expense of the retail location 20 or of the sellers 21 of the various product and services. The information displayed could also be in audio-visual format, and/or include machine readable media such as a CD-ROM for the customer to take with him instead of or in addition to printed material.

In addition to acquiring literature about products and services, the prospective customer will acquire a code 24 from the retail location. The code will include information which is correlated with the identity of the retail location, to enable a computer under control of the seller to determine which retail location is entitled to a finder's fee. With the code 24 in hand, the customer can then log on to the internet to find the specific product or service of interest. The customer can then make a purchase directly from the seller 21 via payment 25, and the seller then proceeds to deliver the product 27 or service directly to the customer 23. Since the retail location has been identified by the use of code 24, the seller is able to pay a finder's fee 26 directly to the retail location 20. This enables the retail location 20 to make a profit without having invested in inventory.

The code 24 may also include information which enables a finder's fee to be calculated, and such information may, if desired, be correlated with a particular product or service. The above-mentioned computer may be programmed to compute such fee.

Additionally, the code 24 may include information which enables a discount to be calculated, and such information may be correlated with a particular product or service. The discount gives the customer an incentive to use the code 24 when the purchase is made, as otherwise the seller would not know whether or not the order was originated by a retail location, or was independently made by the customer.

After the sale is consummated, any future business matters such as returns, repairs, refunds or exchanges are conducted entirely between the customer 23 and the seller 21. The retail location 20 is not involved in these matters, although it may be required to refund the finder's fee in case of a product return.

An optional feature of the invention is automatic e-mail 28 which is sent by the seller's computer to the computer of the retail location confirming that a sale has been made, and including the details of the sale as well as the amount of the finder's fee which is attributable to the retail location. The automatic nature of the e-mail has the effect of increasing the confidence of the proprietor of the retail location in the integrity of the payment process. The computer may also be programmed to actually effect the payment.

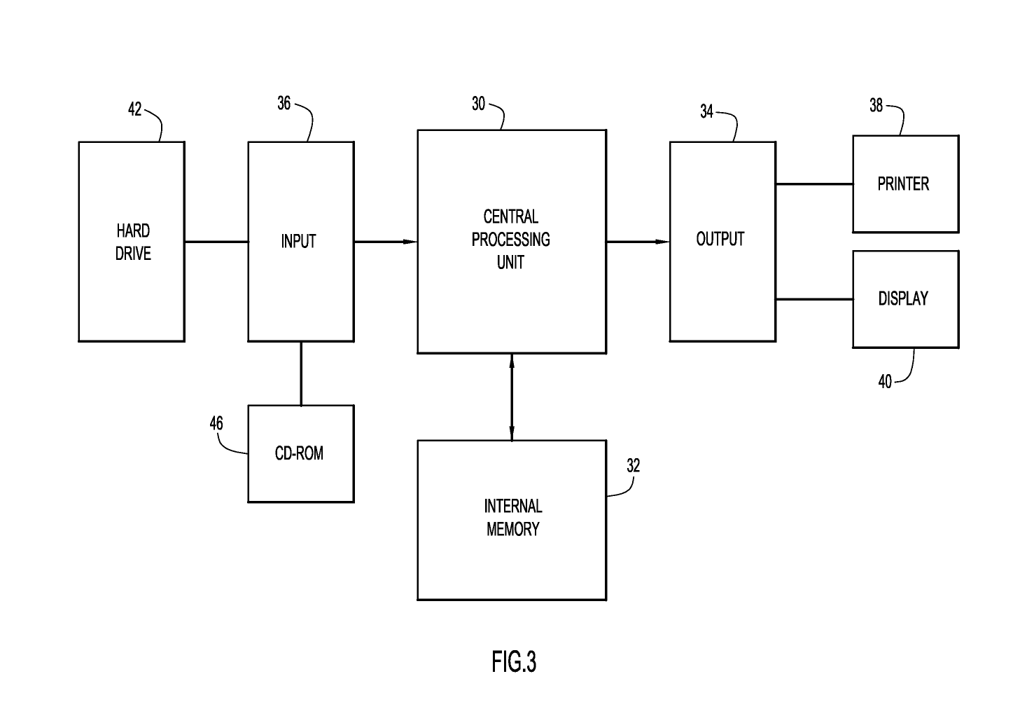

FIG. 3 is a block diagram of an embodiment of a computer which may be used for implementing the invention. It is comprised of central processing unit 30, main internal memory 32, output module 34, and input module 36. Also shown are peripherally located printer 38 and electronic display 40 which are interfaced with output module 34. At the input side, machine readable media are interfaced with input module 36. These may include a hard drive 42 as well as removable media, e.g., CD-ROM 46.

In the operation of an embodiment of the invention, a program to accomplish the functions which have been described above is loaded onto hard drive 42, e.g., from CD-ROM 46. In the alternative, the computer may operate directly from instructions received from removable media such as the CD-ROM. In either case, during operation, the application program is transmitted to main internal memory 32 where it is available to central processing unit 30.

With the application program loaded into the computer it is ready to accept incoming signals over the internet from purchasers of the products or services which the seller is marketing over the internet. The program includes codes 24 which are correlated with the identities of the retail outlets which are in the sales network. The computer is directed to monitor incoming sales information received over the internet. Also, the program instructs the central processing unit 30 to compare any received codes with those stored in memory 32. If a match is found, information including the identity of the retail location is fed to output module 34 and from there to printer 38 and/or display 40. Both the display and printer are conversion devices which convert the electrical signals outputted by output module 34 to a visual format.

The seller then knows which retail location is entitled to a finder's fee, and proceeds to pay such fee to the retail location. The program may also instruct the central processing unit 30 to compute the finder's fee based on information contained in code 24, so that it is not necessary for the seller to manually do so. Code 24 may also contain information which is correlated with a discount which the purchaser will receive, and in this case, information relating to the discount is stored in memory 32 and the central processing unit 30 is programmed to compute the discount, which is also fed to printer 38 and/or display 40. As mentioned above, an optional feature is the automatic transmittal of an e-mail to the computer of the retail outlet containing information relating to the sale including the finder's fee which is attributable to the retail outlet, and the program could include instructions to send such an e-mail.

The following describes one example, among many, of the applicability of the invention. A customer walks into a paint store intending to buy paint for his house. The customer then sees a brochure describing a new product, for example, the product described at www.rollerwall.com. The customer takes some literature about this product including a code, which is identified as a “discount code”. When the customer elects to buy this product on the internet, the customer enters the code and receives a reduced price. The code received by the customer also includes information relating to the identity of the retail location as well as information enabling a finder's fee to be calculated. After the sale is made, the seller sends a finder's fee to the paint store, which did not carry inventory. Thus the product supplier, Rollerwall, sold a product without the expense of up-front advertising, the paint store owner made a profit without the expense of inventory, and the customer found a unique product and acquired it at a discount.

In another example, which relates to services, a customer walks into a wallpaper store to find wallpaper. He then sees a brochure describing the qualifications of a wallpaper hanger. The customer takes some literature including a code, which contains information which is correlated with the identity of the retail location. When the customer elects to hire the wallpaper hanger, the store owner receives a finder's fee.

There are also customers who shop without a specific item in mind. Such a customer could walk into a retail location that carries information about many diverse products rather than actual products, or into a traditional store that carries actual products in addition to such information. The information could describe unique and unusual products or services available from sellers worldwide, and/or more conventional ones. The customer would browse this information to receive ideas about the products or services.

It is noted that the retail location could be a store, a part of a store, a kiosk in a mall, or other type of location which is capable of making the appropriate information available to customers. Also, in connection with the payment of a finder's fee it should be understood that the term “retail location” as used herein includes an entity or individual which the responsible authority connected with the retail location or its franchisor designates or requests to receive the payment. It should further be appreciated that the term “inventory” as used herein does not include samples or demonstrators which are not available for sale, and the term “computer” encompasses various embodiments including a cellular telephone which performs a processing function.

Thus, according to the invention, a method of enabling the sale of products or services which are available on the internet is provided. Additionally, a programmed computer for enabling the sale of products or services which are available on the internet is provided, as well as machine readable media bearing a set of instructions for a computer for enabling the sale of products or services which are available on the internet. Moreover, a method in which a plurality of sellers provides information to at least one retail location relating to products and services which such sellers offer on the internet, is provided.

It should be appreciated that while the invention has been described in connection with illustrative embodiments, variations which do not depart from the spirit of the invention may occur to those skilled in the art, and the subject matter intended to be covered is defined in the claims which are appended hereto.

I claim:

1. A method of enabling the sale of products or services which are available on the internet, comprising:
a. selecting a retail location;
b. providing the retail location with information for customers about products or services available on the internet, which includes;
i. a website address at which the products or services may be purchased, and
ii. a code for use in making purchases, which is correlated with the identity of the retail location,
c. storing the code in a computer which is not located at the retail location;
d. programming the computer to monitor incoming signals received from internet purchasers of the products or services, and to, after a code which is the same as the stored code is received, provide an indication of the identity of the retail location which is correlated with the code; and
e. paying a finder's fee to the retail location.

2. The method of claim 1 wherein the information about products or services comprises printed information.

3. The method of claim 2 wherein a plurality of retail locations is selected, each is provided with said information about products or services, a code which is correlated with each retail location is stored in the computer, and the computer is programmed to, after a code which is the same as any stored code is received, provide an indication of the identity of the retail location correlated with the code.

4. The method of claim 3 wherein the retail locations do not carry an inventory of said products or services available on the internet.

5. The method of claim 4 wherein the code also includes information which enables a finder's fee to be calculated, further comprising:
programming the computer to calculate a finder's fee based on said information which enables a finder's fee to be calculated.

6. The method of claim 5 wherein said information which enables a finder's fee to be calculated is correlated with a particular product or service.

7. The method of claim 4 wherein the code further includes information which enables a discount to be computed.

8. The method of claim 7 further comprising:
programming the computer to compute a discount based on said information enabling a discount to be computed; and
when a sale is made, charging an amount for the sale which includes a deduction corresponding to the discount which is computed.

9. The method of claim 4 further comprising:
programming the computer to automatically send an e-mail to the identified retail location after completion of a sale, which includes information relating to the purchase including the amount of the finder's fee attributable to the retail location.

10. A computer for enabling the sale of products or services which are available on the internet in connection with retail locations which have been provided with information for customers about the products or services and respective codes which are correlated with the respective identities of the retail locations for use in making purchases, the codes being stored in the computer, which is not located at the retail location and is programmed to perform the following steps:
monitoring incoming signals received from internet purchasers of the products and services and,
after a stored code is received, providing an indication of the identity of the retail location which is correlated with the code.

11. The computer of claim 10 wherein said information about products or services comprises printed information, said codes also include information enabling a finder's fee to be calculated, and the computer is programmed to calculate the finder's fee.

12. The computer of claim 11 wherein each code is correlated with a particular product or service.

13. The computer of claim 11 wherein said codes include information which enables a discount to be computed, and wherein said computer is programmed to calculate the discount.

14. The computer of claim 11 which is programmed to automatically send an e-mail to the identified retail location after completion of a purchase which includes information about the purchase including the amount of the finder's fee which is attributable to the retail location.

15. Machine readable media bearing a set of instructions for a computer for enabling products or services which are available on the internet to be sold in connection with retail locations which have been provided with information for customers about the products or services which includes respective codes, stored in the media, which are correlated with the respective identities of the retail locations, which instructions direct the computer to perform the following steps:
monitoring incoming signals received from internet purchasers of the products or services, and
after a stored code is received, providing an indication of the identity of the retail location which is correlated with the code.

16. The machine readable media of claim 15 wherein the codes also include information which enables a finder's fee to be calculated and the media includes instructions for the computer to calculate the finder's fee.

17. The machine readable media of claim 15 wherein the codes also include information enabling a discount to be calculated and the media includes instructions for the computer to calculate the discount.

18. The machine readable media of claim 15 which includes instructions for the computer to automatically send an e-mail to the identified retail location after completion of a sale which includes information about the sale including the amount of the finder's fee which is attributable to the retail location.

19. A method of enabling the sale of products or services which are available on the internet, comprising:
a. selecting a retail location;
b. selecting a plurality of sellers which offer product or services for sale on the internet; and
c. arranging for each seller to
i. provide the retail location with information about the products or services which it sells on the internet, which includes a website address at which the products or services may be purchased and a code for use in making purchases which is correlated with the identity of the retail location;
ii. store the code in a computer within the control of the seller;
iii. programming the computer to monitor incoming signals from internet purchasers of the products or services, and to, after a code is received, provide an indication of the identity of the retail location which is correlated with the code, and
iv. pay a finders fee to the retail location.
